(19) United States
(12) Patent Application Publication
(10) Pub. No.: US 2025/0328981 A1
(43) Pub. Date: Oct. 23, 2025

(54) DATA PROCESSING SYSTEMS

(71) Applicant: Arm Limited, Cambridge (GB)

(72) Inventors: Daren Croxford, Cambridge (GB); Mark Underwood, Cambridge (GB); Joseph Michael Richardson, Cambridge (GB)

(73) Assignee: Arm Limited, Cambridge (GB)

(21) Appl. No.: 19/181,785

(22) Filed: Apr. 17, 2025

(30) Foreign Application Priority Data
Apr. 22, 2024 (GB) 2405601.2

(51) Int. Cl. G06T 1/20

(52) U.S. Cl. CPC G06T 1/20

(57) ABSTRACT

When performing rendering in a graphics processor that comprises plural rendering processors each operable to render regions that a render output is divided into for allocation to the rendering processors, the processing of one or more render outputs by the rendering processors is tracked and the allocation of different regions of a render output to different ones of the rendering processor for processing is controlled based on the tracking of the processing of one or more render outputs by the rendering processors.

### BACKGROUND

The technology described herein relates to data processing systems and, in particular, to data processing systems that allocate processing tasks to processing resources for processing, such as the allocation of regions of a render output to be rendered to rendering processors of a graphics processing system.

Many data processing systems include a plurality of processing resources (e.g. processing cores) that may each process different processing tasks in parallel to one another. This allows a larger processing task (processing job) to be split into smaller processing tasks that are submitted to different ones of the processing resources for processing, to thereby complete the processing of the larger processing task (processing job).

The technology described herein will be described with particular reference to “tile-based” graphics processing by a graphics processor that has a plurality of rendering processors, although embodiments of the technology described herein are more broadly applicable to data processing systems that issue data processing tasks to be completed to a plurality of processing resources in parallel, e.g. to process a data array.

In tile-based graphics processing, a (two dimensional) output array of a rendering process (the “render target” /“render output”) (e.g., and typically, the frame/image that will be displayed to display the scene being rendered) is sub-divided (partitioned) into a plurality of smaller regions, usually referred to as “tiles”, for the rendering process. The tiles are each rendered separately. The rendered tiles are then recombined to provide the complete output array (frame) (render target), e.g. for display.

The tiles can therefore be thought of as regions of the render target area (output frame) that the rendering process operates on. In such arrangements, the render target area (output frame) is typically divided into regularly sized and shaped tiles (they are usually, e.g., squares or rectangles) but this is not essential.

Other terms that are commonly used for “tiling” and “tile based” rendering include “chunking” (the sub-regions are referred to as “chunks”) and “bucket” rendering. The terms “tile” and “tiling” will be used herein for convenience, but it should be understood that these terms are intended to encompass all alternative and equivalent terms and techniques.

In graphics processing systems that comprise a plurality of independent rendering processors (processing (shader) cores), different tiles of a render target may be processed (rendered) in parallel by different rendering processors (cores), thereby potentially reducing the time taken to process (render) the render target. To control the rendering of different tiles by different rendering processors, the tiles may be allocated to particular respective rendering processors for processing and the rendering processors may successively render the tiles allocated to them until all of the required tiles of the render target have been rendered. Which tiles of a render output are allocated to which rendering processors may be controlled according to the availability of the respective rendering processors and a predetermined allocation order (e.g. raster path) for the tiles of the render output

The Applicants believe that there remains scope for improvements to the operation of graphics processing systems that comprise a plurality of rendering processors.

### BRIEF DESCRIPTION OF THE DRAWINGS

Embodiments of the technology described herein will now be described by way of example only and with reference to the accompanying drawings, in which:

FIG. 1 illustrates schematically an exemplary computer graphics processing system.

FIG. 2 illustrates schematically a graphics processor that is in accordance with embodiments of the technology described herein.

FIG. 3 illustrates schematically a cache system in a computer graphics processing system that is in accordance with embodiments of the technology described herein.

FIG. 4 illustrates schematically a graphics processing pipeline executed by the graphics processor in accordance with embodiments of the technology described herein.

FIG. 5A illustrates schematically an example of a sub-set of tiles for which a record is stored in an allocation buffer used to allocate regions of a render output in accordance with embodiments of the technology described herein.

FIG. 5B illustrates schematically the regions of the render output being rendered when the sub-set of tiles is in accordance with FIG. 5A.

FIG. 6A illustrates schematically another example of a sub-set of tiles for which a record is stored in an allocation buffer in accordance with embodiments of the technology described herein.

FIG. 6B illustrates schematically the regions of the render output being rendered when the sub-set of tiles is in accordance with FIG. 6A.

### DETAILED DESCRIPTION

A first embodiment of the technology described herein comprises a method of operating a graphics processor that comprises plural rendering processors each operable to render regions that a render output is divided into for allocation to the rendering processors, the method comprising:
when rendering a render output:
   allocating different regions of the render output to different ones of the rendering processors for processing; and
   each rendering processor processing the region or regions allocated to it;
      the method further comprising:
tracking the processing of one or more render outputs by the rendering processors; and
controlling the allocation of different regions of a render output to different ones of the rendering processor for processing based on the tracking of the processing of one or more render outputs by the rendering processors.

A second embodiment of the technology described herein comprises a graphics processor, comprising:
a plurality of rendering processors, each operable to render regions that a render output is divided into for allocation to the rendering processors;
a region allocation circuit configured to allocate regions of a render output to be processed to rendering processors for processing; and
an allocation controlling circuit configured to:
   track the processing of one or more render outputs by the rendering processors; and
   control the allocation of regions of a render output to the rendering processors for processing based on the tracking of the processing of one or more render outputs by the rendering processors.

The technology described herein relates to a graphics processor that includes plural rendering processors. When processing a render output, respective regions of the render output are allocated to respective ones of the rendering processors for processing.

Processing carried out by the rendering processors for respective regions of a render output (e.g. rasterisation and shading processes) can be used to collectively render the render output, such as for display.

In the technology described herein, the allocation of regions of a render output to rendering processors for processing is controlled based on the tracking of the processing of one or more render outputs by the rendering processors.

As will be discussed further below, the Applicants have recognised that by controlling the allocation of regions of a render output to the rendering processors for processing based on based on the tracking of the processing of one or more render outputs by the rendering processors, the processing of a render output can be made more efficient.

In particular, the applicants have recognised that by controlling the allocation of regions of a render output to the rendering processors for processing based on the tracking of the processing of one or more render outputs by the rendering processors, the rendering processors can process the respective regions allocated to them more efficiently (e.g. by more efficient caching of data to be used for different regions) compared to if the regions are not allocated based on the tracking of the processing of one or more render outputs by the rendering processors.

This can allow the processing of a render output to be completed by the rendering processors more efficiently (and therefore can allow a render output to be made available, e.g. for display, more quickly and/or with a lower amount of processing/energy/data bandwith required) compared to if the processing of one or more render outputs is not tracked and taken into account when allocating regions of the render output to the rendering processors for processing.

In the technology described herein, a render output may be a “final” render output (such as a frame for display), or may be an intermediate render output. For example, a render output may be the output of a draw call or render pass, and in an embodiment there may be a plurality of intermediate draw calls that generate intermediate render outputs, with the final draw call generating the final output (frame) for display.

In the technology described herein, the regions that a render output is divided into for allocation purposes can be any suitable and desired such regions.

The regions that a render output is divided into for allocation purposes are in an embodiment based on rendering tiles that the render output (such as, e.g., a frame to be displayed) is divided into for rendering purposes, where each rendering tile should, and in an embodiment does, comprise a (respective) region (area) of the render output.

However, it is not essential that there is a direct one-to-one correspondence between the rendering tiles and the regions that the render output is divided into for allocation purposes.

In an embodiment, regions that each correspond to a whole number of one or more rendering tiles that the render output is divided into for rendering purposes are allocated to rendering processors for processing. For example, regions that the render output is divided into for allocation purposes may comprise a plurality of rendering tiles, such as a line or an array (e.g. a 2×2 array) of rendering tiles.

When a region comprising a plurality of rendering tiles is allocated to a rendering processor for processing, the rendering processor may process the region by processing the tiles in any suitable manner. For example, a rendering processor may process a region comprising a plurality of tiles in a tile-by-tile manner, where each tile is processed by the rendering processor sequentially, or may process different tiles concurrently, e.g. using different resources of the rendering processor.

The size and shape of the regions may be dictated by the tile configuration that the graphics processor is configured to use and handle.

The regions are in an embodiment all the same size and shape (i.e. regularly sized and shaped regions are in an embodiment used), although this is not essential. The regions are in an embodiment rectangular, and in an embodiment square. The size and number of regions can be selected as desired. Each region may correspond to an array of contiguous sampling positions, for example each region being 16×16 or 32×32 or 64×64 sampling positions in size. A render output may be divided into however many such regions are required to span the render output, for the size and shape of the render output that is being used.

In the technology described herein, the allocation of regions of a render output to rendering processors for processing may be controlled in any suitable manner based on the tracking of the processing of one or more render outputs by the rendering processors.

In an embodiment, the order in which regions of the render output are allocated to the rendering processors for processing is controlled based on the tracking of the processing of one or more render outputs by the rendering processors.

In particular, the allocation of regions of a render output to the rendering processors for processing is in an embodiment controlled (by the allocation controlling circuit) such that the order in which some of the regions of the render output are allocated to the rendering processors for processing is determined after other regions of the render output have been allocated to (and in an embodiment after other regions of the render output have been processed by) the rendering processors.

Accordingly, in an embodiment, the order in which regions of the render output are allocated to the rendering processors for processing is controlled by determining the order in which some of the regions of the render output are allocated to the rendering processors for processing after other regions of the render output have been allocated the rendering processors.

In this regard, the Applicants have recognised that by controlling the order in which regions of a render output are allocated after the allocation and processing of the regions has been begun, the allocation of regions to the rendering processors can take account of the allocation and processing of some of the regions that has already been performed by the rendering processors when determining the order in which to allocate other regions of the render output. The Applicants have recognised that this may allow an allocation order to be provided where rendering processors process the respective regions allocated to them more efficiently than if the allocation order is pre-determined before the allocation of regions of the render output has been begun. For example, this may be because some regions require a larger amount of processing to be performed than would be expected, and so this can be more accurately taken into account once the processing has been performed.

The allocation of regions is in an embodiment controlled to try and exploit potential spatial coherency between nearby regions in a render output.

In this regard, as regions closely located to one another are typically likely to share at least some rendering state/data (e.g. textures used), allocating regions so that successively processed regions are regions located close to one another can increase the likelihood of being able to exploit this potential spatial coherency by a rendering processor reusing the rendering state/data for successively processed regions or tiles, and this can be beneficial to the efficiency of the rendering process.

Accordingly, (at least some of) the regions of a render output may be allocated in an order based on suitable path or pattern that tries to exploit spatial coherency. For example, the order in which (at least some of the) regions of a render output are allocated to be processed by a rendering processor may be based on raster-order, Hilbert-order (“U-order”), Morton-order (“Z-order”) or Peano-order.

However, the Applicants have recognised that when the next rendering processor that becomes available to process a region is allocated the next region to be allocated according to a particular path or pattern, if the last region processed by a rendering processor is a region that required a relatively larger amount of processing compared to regions processed by other rendering processors, the other rendering processors may have processed many regions in the path or pattern while the rendering processor has processed the region that required a relatively larger amount of processing, such that the next region to be allocated according to the particular path or pattern may be relatively distant to the region that required a relatively larger amount of processing, and therefore the rendering processor is unlikely to be able to exploit potential spatial coherency between the region that required a relatively larger amount of processing and the next region to be allocated according to the particular path or pattern.

The Applicants have recognised that by controlling the order in which regions of a render output are allocated after the allocation and processing of the regions has been begun, there is the potential to more reliably (and/or to a greater extent) exploit spatial coherency between nearby regions in a render output compared to if the allocation order is predetermined before allocation of the regions is begun.

The order in which regions of the render output are allocated to the rendering processors for processing may be controlled in any suitable manner.

In an embodiment, controlling the allocation of regions of a render output to the rendering processors for processing based on the tracking of the processing of one or more render outputs by the rendering processors comprises:
(the allocation controlling circuit) selecting which region of the render output a rendering processor is next allocated (by the region allocation circuit) to process based on the tracking of the processing of one or more render outputs by the rendering processors.

For example, this may be determined when (and, in an embodiment, each time) a rendering processor is available for processing a (next) region of a render output.

In an embodiment, a provisional allocation order for regions of a render output is determined and when a rendering processor is available for processing a (next) region of the render output, which region of the render output the rendering processor is next allocated to process is based on the provisional allocation order and the tracking of the processing of one or more render outputs by the rendering processors.

In this case, it may be selected whether (or not) to allocate a region of the render output according to the provisional allocation order based on the tracking of the processing of one or more render outputs by the rendering processors.

Any suitable provisional allocation order may be used.

In an embodiment, the provisional allocation order is based on locations of regions within the render output relative to one another, and is in an embodiment selected to try to exploit spatial coherency. For example, the provisional allocation order may be based on raster-order, Hilbert-order (“U-order”), Morton-order (“Z-order”) or Peano-order.

However, by tracking the processing of one or more render outputs by the rendering processors, it can be determined whether the overall efficiency with which a render output is processed by the rendering processors is expected to be increased by deviating from the provisional allocation order, as appropriate based on the tracking.

In one embodiment, the graphics processor is operable for any region of a render output still required to be allocated for processing to be selected as the region of the render output a rendering processor is next allocated to process based on the tracking of the processing of one or more render outputs by the rendering processors.

In another embodiment, a region of the render output a rendering processor is next allocated to process is selected from a sub-set of regions of the render output comprising regions that can be allocated to the rendering processor next, wherein the region from the sub-set that is selected is based on the tracking of the processing of one or more render outputs by the rendering processors.

Thus, in an embodiment, the allocation controlling circuit is configured to:
control which regions are present within a sub-set of regions of a render output, wherein the sub-set comprises regions that can be next allocated to a rendering processor for processing; and
select which region from the sub-set is next allocated to a rendering processor for processing based on the tracking of the processing of one or more render outputs by the rendering processors.

Which regions of the render output the sub-set of regions comprises can be changed over time, and is in an embodiment based on the provisional allocation order.

Thus, in an embodiment, which region of a render output a rendering processor is next allocated to process is selected from a sub-set of regions of the render output, wherein which regions are present within the sub-set is based on the provisional allocation order, and which region is selected from the sub-set to be next allocated to the rendering processor is based on the tracking of the processing of one or more render outputs by the rendering processors.

For example, in an embodiment, the sub-set of regions comprises regions having positions in the provisional allocation order within a particular number of regions after the position of the next region to be allocated according to the provisional allocation order.

In an embodiment, the region allocation circuit can allocate a region to a rendering processor for processing by issuing a rendering task to the rendering processor, wherein the rendering task comprises a set of commands and/or data that the rendering processor can utilise to process the region that the rendering task corresponds to.

The graphics processor can in an embodiment generate such a rendering task independent of when a rendering processor is available for processing the region that the rendering task corresponds to. A region can then be allocated to a rendering processor by issuing the rendering task corresponding to the region to a rendering processor as and when it is appropriate to do that.

Thus, in an embodiment, rendering tasks for processing a render output are generated, wherein different ones of the rendering tasks correspond to different ones of the regions of the render output, and wherein a region of the render output is allocated to a rendering processor for processing by issuing a rendering task corresponding to the region to the rendering processor for processing.

According to an embodiment, the graphics processor comprises a rendering task generating circuit configured to generate rendering tasks for processing a render output, wherein different ones of the rendering tasks correspond to different ones of the regions of the render output, and wherein the rendering processors are operable to process regions of the render output by processing the respective rendering tasks corresponding to the respective regions;
and wherein the region allocation circuit is configured to allocate a region of a render output to a rendering processor for processing by issuing a rendering task corresponding to the region to the rendering processor for processing.

In an embodiment, rendering tasks for a render output are generated in an order according to a provisional allocation order for the regions of the render output.

In an embodiment, the allocation controlling circuit is configured to control which regions are present within the sub-set based on an order in which the rendering tasks are generated.

However, the order in which generated rendering tasks are issued for processing is in an embodiment based on the tracking of the processing of one or more render outputs by the rendering processors, such that the rendering tasks are not necessarily issued (the regions are not necessarily allocated) in the order in which the rendering tasks are generated.

Thus, the allocation controlling circuit is in an embodiment configured to control based on the tracking of the processing of one or more render outputs by the rendering processors whether or not to issue a rendering task to a rendering processor according to the order in which the rendering tasks are generated by the rendering task generating circuit.

The sub-set of regions in an embodiment comprises (only) regions for which rendering tasks have been generated (such that the regions in the sub-set of regions are ready and available to be allocated by issuing a corresponding rendering task to a rendering processor for processing).

For example, in an embodiment, the sub-set of regions comprises all regions for which rendering tasks have been generated.

In another embodiment, the sub-set of regions comprises regions for which rendering tasks have been generated and that fulfil some other criteria.

For example, in an embodiment, the sub-set of regions comprises regions for which rendering tasks have been generated and that have positions in the provisional allocation order within a particular number of regions after the position of the next region to be allocated according to the provisional allocation order.

In an embodiment, the sub-set of regions is a fixed number of regions.

In an embodiment, a region is added to the sub-set when another region is removed from the sub-set.

In an embodiment, a region is removed from the sub-set when the region is allocated for processing.

In another embodiment, the allocation controlling circuit tracks which regions in the sub-set have been allocated for processing (but does not necessarily remove a region from the sub-set when it is allocated). This can, for example, ensure that particular ones of the regions from the sub-set are allocated for processing before new region(s) are added to the sub-set.

In an embodiment, which regions are within the sub-set is controlled to maintain a maximum number of places the regions within the sub-set are apart from one another in the provisional allocation order. In an embodiment, the allocation controlling circuit tracks which regions in the sub-set have been allocated for processing, removes a region from the sub-set when the region is allocated for processing and the region has the earliest position in the provisional allocation order compared to other regions (currently) within the sub-set, and when a region is removed from the sub-set another region is added to the sub-set.

A record of which regions are within the sub-set can be maintained in any suitable manner.

In an embodiment, the graphics processor comprises a buffer for storing a record of a sub-set of regions of a render output that can be next allocated to a rendering processor for processing.

The record may, for example, comprise rendering tasks for the regions in the sub-set (such that the regions in the sub-set are those which correspond to rendering tasks stored in the buffer), or the record may comprise an indication of which rendering tasks correspond to regions within the sub-set (such that the regions in the sub-set are those which correspond to rendering tasks indicated by the record).

The processing of one or more render outputs by the rendering processors can be tracked in any suitable manner and any suitable combination of different manners of tracking may be used.

In an embodiment, the allocation of regions of a render output to the rendering processors for processing is controlled based on the tracking of the processing of (at least) the (same) render output.

In an embodiment, the allocation of regions of a render output to the rendering processors for processing is in an embodiment controlled such that the order in which some of the regions of the render output are allocated to the rendering processors is based on the tracking of the processing of other regions of the (same) render output.

In an embodiment, tracking the processing of one or more render outputs by the rendering processors comprises tracking which region or regions of a render output are currently being processed by the rendering processors.

In an embodiment, the position(s) in the provisional allocation order of the region or regions of a render output currently being processed by the rendering processors is tracked.

A region may be selected to be next allocated to a rendering processor for processing based on which region or regions of a render output are currently being processed by the rendering processors.

For example, a region to be allocated next may be selected to maintain the regions being processed close to one another (in location within the render output and/or position within the provisional allocation order).

In an embodiment, tracking the processing of one or more render outputs by the rendering processors comprises tracking which region or regions of a render output are processed by which of the rendering processors.

For example, a region may be selected to be allocated to a rendering processor for processing based on which other region or regions the rendering processor has processed, and for example based on a location of the selected region relative to other region(s) the rendering processor has processed (e.g. has last processed or processed relatively recently, such as a particular (e.g. predefined) number of previous successively processed regions by the rendering processor).

In an embodiment, tracking the processing of one or more render outputs by the rendering processors comprises tracking a rate at which different ones of the rendering processors process regions of a render output.

Any suitable measure of a rate at which different ones of the rendering processors process regions of a render output may be tracked. For example, an amount of processing time used by a respective rendering processor to process one or more regions may be tracked, or a number of regions processed by different ones of the rendering processors may be tracked.

For example, when different groups of rendering processors are identified to be processing regions at different rates, regions close to one another may be allocated to rendering processors in the same group to try to maintain synchronisation/locality of the rendering processors within the same group.

In an embodiment, the allocation of regions of a render output to the rendering processors for processing is controlled (by the allocation controlling circuit) based on the tracking of the processing of another render output.

In this regard, the Applicants have recognised that regions representing corresponding locations in different render outputs within a series of render outputs are typically likely to share at least some rendering state/data (e.g. textures used), and that at least some regions of a render output may be able to be processed in a manner that can re-use some rendering state/data for another render output.

In an embodiment, the graphics processor is operable for the rendering processors to process regions of different render outputs concurrently with one another. For example, when all of the regions of a first render output have been allocated for processing, regions of a second render output are in an embodiment begun to be allocated for processing before the rendering processors (necessarily) finish processing (all) the regions of the first render output.

However, it may still be possible to re-use some rendering state/data for regions of different render outputs that are not processed concurrently but where data for a render output remains stored in a cache for a rendering processor or rendering processors when another render output is processed (for example when the regions of the different render outputs are processed close in time to one another).

A rendering processor may be able to re-use some rendering state/data when it processes regions representing corresponding locations in different render outputs.

Accordingly, in an embodiment, allocation of regions of a (first) render output to the rendering processors for processing is controlled based on the tracking of the processing of another (second) render output by:
tracking which region or regions of a first render output are allocated to which of the rendering processors for processing; and
selecting a region of a second render output to allocate to a rendering processor for processing based on which region or regions of the first render output the rendering processor was allocated to process (and in an embodiment based on whether the rendering processor was allocated to process a region of the first render output representing a corresponding location to the selected region of the second render output).

A rendering processor may be able to re-use some rendering state/data when it processes a region representing a corresponding location to a region in a different render output that is being processed or has been processed relatively recently, based, for example, on a cache shared by different rendering processors (still) containing data for the region of the different render output.

Accordingly, in an embodiment, allocation of regions of a (first) render output to the rendering processors for processing is controlled based on the tracking of the processing of another (second) render output by (the allocation controlling circuit):
tracking when respective regions of a first render output are processed by the rendering processors; and
selecting a region of a second render output to allocate to a rendering processor for processing based on when a region or regions of the first render output are processed by a rendering processor or rendering processors (and in an embodiment based on when a region of the first render output is processed that represents a corresponding location to the selected region of the second render output).

When respective regions of a first render output are processed by the rendering processors may be tracked in any suitable manner, for example based on a time that the regions begin or end processing, or based on the order in which the respective regions are allocated to be processed.

As discussed above, the order in which the region allocation circuit allocates regions of a render output to rendering processors for processing is in an embodiment controlled by the allocation controlling circuit, and the region allocation circuit can in an embodiment allocate a region to a rendering processor for processing by issuing a rendering task to the rendering processor, wherein the rendering task comprises a set of commands and/or data that the rendering processor can utilise to process the region that the rendering task corresponds to.

A job controller of the graphics processor in an embodiment comprises a rendering task generating circuit for generating rendering tasks. Thus, the graphics processor in an embodiment comprises a job controller that can generate a set of rendering tasks for a render output to be processed by the graphics processor, wherein different rendering tasks correspond to different regions of the render output. The region allocation circuit in an embodiment also forms part of the job controller.

In an embodiment, the graphics processor is operable so that the rendering tasks may correspond to an individual tile, a whole number of plural tiles, or to part(s) of tiles (sub-tile(s)). When a region corresponding to more than one tile is allocated to a rendering processor for processing, the rendering processor in an embodiment divides the processing it performs to process the region based on the tiles that the region corresponds to.

In an embodiment, when a rendering processor is allocated a region of a render output for processing, the rendering processor will identify each tile that the region corresponds to, and is in an embodiment configured to determine, for each tile that the region corresponds to, whether it is the entire tile or only part of the tile (a sub-tile) that the region allocated to the rendering processor corresponds to. The rendering processor can then process the region by processing each tile (or sub-tile) that the region corresponds to. For example, the rendering processor may process each tile (or sub-tile thereof) that a region corresponds to one after another, or may process different tiles in parallel with one another (e.g. by different sets of resources of the rendering processor processing different tiles or sub-tiles).

A (and each) rendering processor can process (the tiles or sub-tiles of) the regions and sub-regions it is allocated in any suitable and desired manner, and subject to any operation required for the purposes of the technology described herein, in an embodiment does this in the normal manner for the graphics processor and graphics processing system in question.

Thus, in an embodiment, a tile of a render output is processed by determining primitives to be processed for the tile and rasterising primitives for the tile to generate graphics fragments for shading (and then shading (rendering) the graphics fragments). The rendering processors accordingly in an embodiment comprise a rasterisation stage (rasterisation circuit) that operates to and is configured to rasterise primitives into graphics fragments for processing, and a fragment processing (shading) stage that processes the graphics fragments.

The rendering process may also or instead include (performing) ray-tracing or hybrid ray-tracing, if desired.

The primitives that need to be processed for a tile are in an embodiment determined (identified) based on data structures that allow the primitives required to be processed to process respective tiles of the render output to be determined.

The graphics processor accordingly in an embodiment comprises an appropriate tiler (tiling unit/circuit/stage) that generates data structures (e.g. primitive lists) that allow the primitives required to be processed to process respective tiles of the render output to be determined.

Once the tiling stage (tiling circuit) has completed the preparation of the data structures, then each tile can be processed (rasterised and rendered).

The rasterisation stage (rasterisation circuit) in an embodiment determines what sampling positions of the render output fall within a primitive (are covered by the primitive), and generates graphics fragments having appropriate positions (representing appropriate sampling positions) for rendering the primitive accordingly. Each graphics fragment may correspond to a single sampling position, or a set of plural sampling positions (e.g. 2×2 sampling positions), as desired.

The rendering stage (rendering circuit) should, and in an embodiment does, render fragments generated by the rasterisation stage/rasterisation circuit to generate rendered (fragment) data.

The rendering process performed by the rendering stage (rendering circuit) may comprise one or more fixed function rendering stages, such as texture mappers, blenders, effects units, etc..

In an embodiment, the rendering process performs one or more fragment shading operations on a fragment to derive rendered fragment data, such as colour values (e.g. red, green and blue (RGB) colour values) and an “alpha” (transparency) value, for shading each covered sampling position in the render output that that the fragment corresponds to. The fragment shading operations may involve any suitable processes for shading fragments, such as executing one or more fragment shading programs on the fragments, applying textures to the fragments, ray-tracing, etc..

Thus, in an embodiment the rendering stage (rendering circuit) comprises a fragment shader (a shader pipeline) (i.e. a programmable pipeline stage that is operable to and can be programmed to carry out fragment shading programs on fragments in order to render them).

The rendering processors should and in an embodiment do (each) comprise a tile buffer for storing rendered fragment data, such as colour and depth values associated with (the sampling positions of) fragments. In an embodiment a tile buffer comprises a plurality of buffers for storing different parts of the rendered data, such as a colour buffer for storing colour values and a depth buffer for storing depth values. The rendered data can in an embodiment be written out of the tile buffer to, for example, a frame buffer or “main” memory when appropriate to do so (e.g. once all of the rendered data for a tile has been generated).

The above describes the particular elements of the graphics processor that are involved in the operation in the manner of the technology described herein. As will be appreciated by those skilled in the art, the graphics processor can otherwise include, and in an embodiment does include, and execute, any one or one or more, and in an embodiment all, of the other processing circuits/stages that graphics processors may (normally) include.

Thus, for example, the graphics processor in an embodiment also includes one or more of, and in an embodiment plural of, and in an embodiment all of: one or more shader stages/circuits (such as a vertex shader or shaders); one or more (early and/or late) culling (e.g. depth and/or stencil) testers (culling (e.g. depth and/or stencil) test stages), a blender (blending stage), etc..

The writing out of the rendered data from the tile buffer to the output buffer (in memory) may also comprise, for example, downsampling and/or compressing the data from the tile buffer as it is written out. Other arrangements for the graphics processing that is being executed would, of course, be possible.

The render output to be generated may comprise any render output that can be and is to be generated by a graphics processor and processing pipeline, such as a frame for display, a render-to-texture output, etc.. In an embodiment, the render output is an output frame, and in an embodiment an image.

In an embodiment, the various functions of the technology described herein are carried out on a single graphics processing platform that generates and outputs the (rendered) data that is, e.g., written to a frame buffer for a display device.

The graphics processor may also be in communication with a host microprocessor, and/or with a display for displaying images based on the output of the graphics processor.

Although the embodiments of the technology described herein described above relate to graphics processing, it is believed that controlling the allocation of different regions of a data array to different processing circuits for processing based on the tracking of the processing of one or more data arrays by the processing circuits in the manner described above for processing a render output may be novel and inventive in its own right.

Thus, a third embodiment of the technology described herein comprises a method of operating a data processor that comprises plural processing circuits each operable to process regions that a data array is divided into for allocation to the processing circuits, the method comprising:
when processing a data array:
   allocating different regions of the data array to different ones of the processing circuits for processing; and
   each processing circuit processing the region or regions allocated to it;
      the method further comprising:
tracking the processing of one or more data arrays by the processing circuits; and
controlling the allocation of different regions of a data array to different ones of the processing circuits for processing based on the tracking of the processing of one or more data arrays by the processing circuits.

A fourth embodiment of the technology described herein comprises a data processor, comprising:
a plurality of processing circuits, each operable to process regions that a data array is divided into for allocation to the processing circuits;
a region allocation circuit configured to allocate regions of a data array to be processed to processing circuits for processing; and
an allocation controlling circuit configured to:
   track the processing of one or more data arrays by the processing circuits; and
   control the allocation of regions of a data array to the processing circuits for processing based on the tracking of the processing of one or more data arrays by the processing circuits.

The third and fourth embodiments of the technology described herein may comprise any of the optional features described above in relation to the first and second embodiments, as appropriate.

For example, in an embodiment the order in which regions of the data array are allocated to the processing circuits for processing is controlled based on the tracking of the processing of one or more data arrays by the processing circuits.

The order in which regions of the data array are allocated to the processing circuits for processing is in an embodiment controlled such that the order in which some of the regions of the data array are allocated to the processing circuits for processing is determined after other regions of the data array have been allocated to the processing circuits.

In an embodiment, when a processing circuit is available for processing a region of the data array, which region of the data array the processing circuit is next allocated to process is based on a provisional allocation order and the tracking of the processing of one or more data arrays by the processing circuits. In an embodiment, which region of a data array a processing circuit is next allocated to process is selected from a sub-set of regions of the data array, wherein which regions are present within the sub-set is based on the provisional allocation order, and which region is selected from the sub-set to be next allocated to the processing circuit is based on the tracking of the processing of one or more data arrays by the processing circuits.

In an embodiment, processing tasks for processing the data array are generated, wherein different ones of the processing tasks correspond to different ones of the regions of the data array, and wherein a region of the data array is allocated to a processing circuit for processing by issuing a processing task corresponding to the region to the processing circuit for processing;
wherein the processing tasks for the data array are in an embodiment generated in an order according to the provisional allocation order.

Tracking the processing of one or more data arrays by the processing circuits in an embodiment comprises tracking which region or regions of a data array are currently being processed by the processing circuits.

Tracking the processing of one or more data arrays by the processing circuits in an embodiment comprises tracking which region or regions of a data array are processed by which of the processing circuits.

Tracking the processing of one or more data arrays by the processing circuits in an embodiment comprises tracking a rate at which different ones of the processing circuits process regions of a data array.

In an embodiment, the allocation of regions of a data array to the processing circuits for processing is controlled such that the order in which some of the regions of the data array are allocated to the processing circuits is based on the tracking of the processing of other regions of the data array.

In another embodiment, the allocation of regions of a data array to the processing circuits for processing is controlled based on the tracking of the processing of another data array.

In an embodiment, the allocation of regions of a data array to the processing circuits for processing is controlled based on the tracking of the processing of another data array by:
tracking which region or regions of a first data array are allocated to which of the processing circuits for processing; and
selecting a region of a second data array to allocate to a processing circuit for processing based on which region or regions of the first data array the processing circuit was allocated to process.

The technology described herein can be implemented in any suitable system, such as a suitably configured micro-processor based system. In some embodiments, the technology described herein is implemented in computer and/or micro-processor based system.

In embodiments, the graphics processor or data processor comprises, and/or is in communication with, one or more memories and/or memory devices that store the data described herein, and/or that store software for performing the processes described herein.

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuits of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics and/or data processor can otherwise include any one or more or all of the usual functional units, etc., that graphics and/or data processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

The present embodiments relate to computer graphics processing.

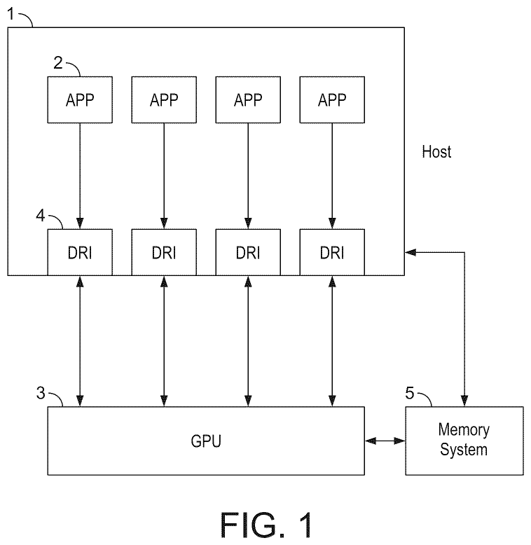

FIG. 1 shows a typical computer graphics processing system.

An application 2, such as a game, executing on a host processor (CPU) 1 will require graphics processing operations to be performed by an associated graphics processor (graphics processing unit (GPU)) 3 that executes a graphics processing pipeline. To do this, the application will generate API (Application Programming Interface) calls that are interpreted by a driver 4 for the graphics processor 3 that is running on the host processor 1 to generate appropriate commands to the graphics processor 3 to generate graphics output required by the application 2. To facilitate this, a set of “commands” will be provided to the graphics processor 3 in response to commands from the application 2 running on the host system 1 for graphics output (e.g. to generate a frame to be displayed).

As shown in FIG. 1, the graphics processing system will also include an appropriate memory system 5 for use by the host CPU 1 and graphics processor 3.

When a computer graphics image is to be rendered (e.g. for display), it is usually first defined as a series of primitives (polygons), which primitives are then divided (rasterised) into graphics fragments for graphics rendering in turn. During a normal graphics rendering operation, the renderer will modify the (e.g.) colour (red, green and blue, RGB) and transparency (alpha, a) data associated with each fragment so that the fragments can be displayed correctly. Once the fragments have fully traversed the renderer, their associated data values are then stored in memory, ready for output, e.g. for display.

In the present embodiments, graphics processing is carried out in a pipelined fashion, with one or more pipeline stages operating on the data to generate the final output, e.g. frame that is displayed.

The present embodiments relate to tile-based graphics processing in which tiles that a render output is divided into for rendering purposes can be processed by a rendering processor executing a graphics processing pipeline to process and output a tile separate from the processing or outputting of other tiles.

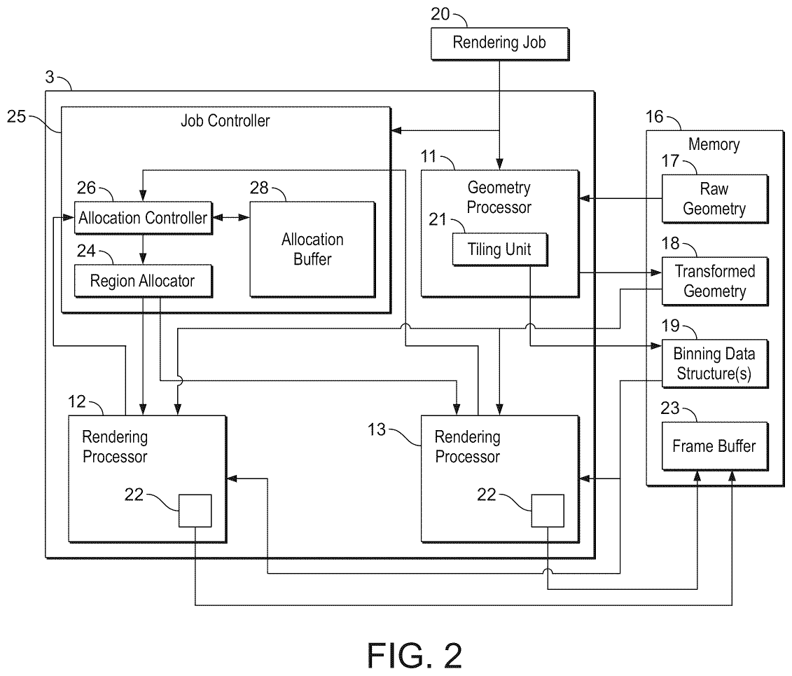

FIG. 2 shows schematically the graphics processor 3 in the embodiments. The graphics processor 3 is a tile-based graphics processor and includes a geometry processor 11 and plural rendering processors (renderers/shader cores) 12, 13, all of which can access memory 16 of the memory system 5. The memory 16 may be local to (e.g. “on-chip” with) the geometry processor 11 and rendering processors 12, 13, or may be an external memory (e.g. “main” memory) that can be accessed by the geometry processor 11 and the rendering processors 12, 13. In an embodiment, the graphics processor comprises one unified processor that comprises the geometry processor 11 and the rendering processors 12, 13.

FIG. 2 shows a graphics processor 3 with two rendering processors 12, 13, but other configurations of plural rendering processors can be used if desired.

The memory 16 stores, inter alia, and as shown in FIG. 2, a set of raw geometry data 17 (which is, for example, provided by a graphics processor driver 4 or an API 2 running on the host system (microprocessor) 1 for the graphics processor 3), a set of transformed geometry data 18 (which is the result of various transformation and processing operations carried out on the raw geometry 17), and a set of binning data structure(s) 19 that allow the primitives required to be processed to process respective tiles of the render output to be determined.

The binning data structure(s) 19 may, for example, comprise primitive lists that each correspond to respective regions (e.g. tile(s)) that the render output, such as a frame to be displayed, to be generated by the graphics processor 3 is divided into for rendering purposes, and contain data, commands, etc., for the respective primitives that are to be processed for the respective regions (e.g. tile(s)) that the list corresponds to.

In this case, sets of regions for which primitive lists are prepared are in an embodiment arranged in a hierarchy of sets of regions, wherein each set of regions corresponds to a layer in the hierarchy of sets of regions, and wherein regions for which primitive lists are prepared in progressively higher layers of the hierarchy are progressively larger. Each region for which a primitive list can be prepared in a lowest layer of the hierarchy in an embodiment corresponds to a single tile of the render output. Other configurations for the primitive lists would, however, be possible.

The transformed geometry data 18 comprises, for example, transformed vertices (vertex data), etc.

The geometry processor 11 takes as its input the raw geometry data 17 stored in the memory 16 in response to the graphics processor 3 receiving commands to execute a rendering job 20 from, e.g., a graphics processor driver 4, and processes that data to provide transformed geometry data 18 (which it then stores in the memory 16) comprising the geometry data in a form that is ready for placement in the render output (e.g. frame to be displayed).

The geometry processor 11 and the processes it carries out can take any suitable form and be any suitable and desired such processes. The geometry processor 11 may, e.g., include a programmable vertex shader that executes vertex shading operations to generate the desired transformed geometry data 18.

As shown in FIG. 2, the geometry processor 11 also includes a tiling unit 21. This tiling unit 21 carries out the process of preparing the binning data structure(s) 19 which is then used to identify the (visible, non-culled) primitives that should be rendered for each tile that is to be rendered to generate the render output (which in this embodiment is a frame to be rendered for display). To do this, the tiling unit 21 takes as its input the transformed and processed vertex data 18 (i.e. the positions of the primitives in the render output), builds binning data structure(s) 19 using that data, and stores those binning data structure(s) as the binning data structure(s) 19 in the memory 16.

To prepare the binning data structure(s) 19, the tiling unit 21 takes each transformed primitive in turn, determines the location for that primitive, and then includes the primitive in the binning data structure(s) 19 in a manner that allows the region(s) that the primitive in question is determined as potentially falling within (intersecting) to be determined by reading the binning data structure(s). This may be carried out with, for example, a bounding box binning technique, or with an exact binning technique.

In the present embodiment, to process a tile or part thereof, a rendering processor takes the transformed primitives identified from the binning data structure(s) applying to the tile and rasterises and renders those primitives to, as appropriate, generate rendered graphics data in the form of output fragment (sampling point) data for each respective sampling position within the tile that it is processing. To this end, each rendering processor includes a respective rasterising unit, rendering unit and set of one or more tile buffers 22 that store the rendered data generated by the rendering processor. Once a rendering processor has completed its processing of a given tile or part thereof, the stored, rendered data for that tile or part thereof is output from the tile buffer(s) 22 to the output render target, which in this embodiment is a frame buffer 23 for a display.

As discussed above, the present embodiments relate to a tile-based graphics processor 3 comprising plural rendering processors 12, 13 in which a render output (e.g. frame to be rendered) is rendered as plural individual rendering regions that each correspond to one or more tiles or parts thereof. Thus, a respective rendering processor can render a region of the render output that it has been allocated by rendering tile(s) or parts thereof corresponding to the allocated region, and, when the rendering processor has processed a tile or part thereof within a region it is processing, write the rendered data for that tile or part thereof to the frame buffer 23. When one tile or part thereof within a region allocated to a rendering processor has been processed, another tile or part thereof (when present) within the region may be processed by the rendering processor and the rendered data for that tile or part thereof written to the frame buffer 23. When a rendering processor has finished processing one region, another region of the render output that is yet to be processed can be allocated to the rendering processor for processing. In this manner, each tile will be processed and output separately from other tiles but a respective tile may itself be output together or as separate parts (sub-tiles).

Thus, respective regions of a render output are allocated as rendering tasks to the respective rendering processors 12, 13 for processing. This operation is performed by a region allocator (region allocation circuit) 24.

In the present embodiment, the region allocator 24 is part of a job controller 25 of the graphics processor 3. The job controller 25 further comprises an allocation controller 26 that will, inter alia, issue commands and data to the region allocator 24 for the region allocator 24 to then schedule appropriate rendering tasks for and onto the graphics processing pipeline 100 of a rendering processor 12, 13. The generation of a render output by execution of a rendering job 20 is carried out by the processing of the rendering tasks. Thus, the region allocator 24 operates to allocate rendering tasks to the rendering processors 12, 13, for processing for a rendering job 20 that is to be performed by the graphics processor 3.

The job controller 25 further comprises an allocation buffer 28 that stores a record of a sub-set of regions of the render output. The sub-set comprises regions that can be allocated to a rendering processor next, and the regions in the sub-set vary over the allocation carried out for the render output. The allocation controller 26 tracks the processing of one or more render outputs by the rendering processors 12, 13 and controls which of the regions (currently) within the sub-set are selected to be next allocated to a rendering processor 12, 13 by the region allocator 24. Regions of a render output can be added to the sub-set according to a provisional allocation order. However, by maintaining the record of the sub-set and selecting regions from the sub-set based on the tracking of the processing, the allocation controller 26 can thereby dynamically adjust the order in which regions are allocated compared to the provisional allocation order. This dynamic adjustment can be carried out as and when it is determined to be appropriate to do that based on the tracking of the processing of one or more render outputs.

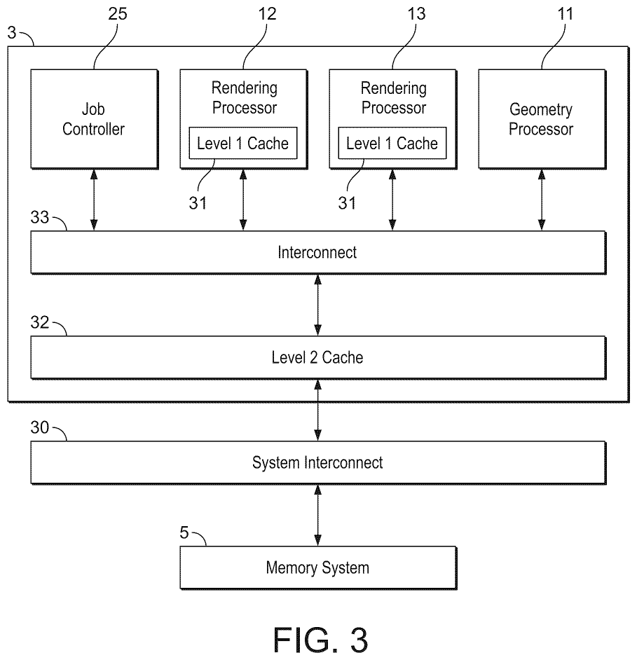

For example, the allocation order can be adjusted in a manner that is expected to allow more efficient caching of data used by the rendering processors 12, 13, based on what other region(s) the rendering processors 12, 13 have previously processed. This is explained further below with reference to FIG. 3.

FIG. 3 shows the memory system 5 and graphics processor 3 of the graphics processing system.

As shown in FIG. 3, in between the memory system 5 and the graphics processor 3, there is a system interconnect 30 that is operable to transfer data from the memory system 5 to the graphics processor 3. Data, such as textures, geometry to be rendered, etc. can be transferred from the memory system 5 to the graphics processor via the system interconnect 30, the graphics processor 3 can process that data, and then return data to the memory system 5 (e.g. in the form of rendered data and/or frames to be displayed).

The graphics processor 3 comprises two cache levels, including Level 1 caches 31 of the rendering processors 12, 13 and a Level 2 cache 32 from which data can be transferred to, and received from, the rendering processors 12, 13, the job controller 25 and the geometry processor 11 via an interconnect 33 of the graphics processor 3. Other cache hierarchy arrangements would be possible, such as comprising more than two cache levels, if desired. For example, a Level 3 cache may be provided relatively close to the memory system 5 than the Level 2 cache 32.

During the processing of a render output, data stored within the Level 1 caches 31 or Level 2 cache may be retained until there is a need for more space to be made available in the respective cache for other data, in which case any previous data can be removed or overwritten, as appropriate.

When a region is allocated to a rendering processor for processing 12, 13 and the rendering processor 12, 13 already has some of the data required to process the region in its Level 1 cache 31 then the rendering processor 12, 13 can re-use this data and thereby reduce the amount of data that is required to be transferred to the rendering processor 12, 13 to process the region.

Furthermore, when a region is allocated to a rendering processor for processing 12, 13 and data required to process the region is already stored in the Level 2 cache 32 (but not the Level 1 cache 31 of the rendering processor 12, 13), then this data can be transferred to the Level 1 cache 31 of the rendering processor 12, 13 from the Level 2 cache 32 without the data needing to be required to be retrieved from the memory system 5. This can thereby reduce the amount of data that needs to be retrieved from the memory system 5 to process the region, compared to if the data is not stored in either the Level 1 cache 31 or the Level 2 cache 32. The same principle applies to other cache hierarchy arrangements comprising more than two cache levels, where if data is stored in a cache level relatively closer to the rendering processors 12, 13 then this can reduce the amount of data that needs to be fetched from main memory or a cache level relatively closer to the main memory (and which cache level(s) the data is stored in can depend on how recently the data was previously required by a rendering processor 12, 13).

Accordingly, by controlling the allocation of regions based on the tracking of the processing of one or more render outputs, the allocation can be carried out in a manner that allows for more efficient caching of the data. For example, a region can be allocated to a rendering processor 12, 13 that (at least more likely) already has some of the required data to process the region in its Level 1 cache 31, such as because the previous region it has processed is located close to the allocated region and may therefore be likely to share some of the required data (e.g. textures). In another example, a region can be allocated to one of the rendering processors 12, 13 when data required to process the region is (likely to be) already stored in the Level 2 cache 32, for example because a region in a corresponding location within another render output (and that may therefore be likely to share some of the required data) has been recently processed by a rendering processor 12, 13.

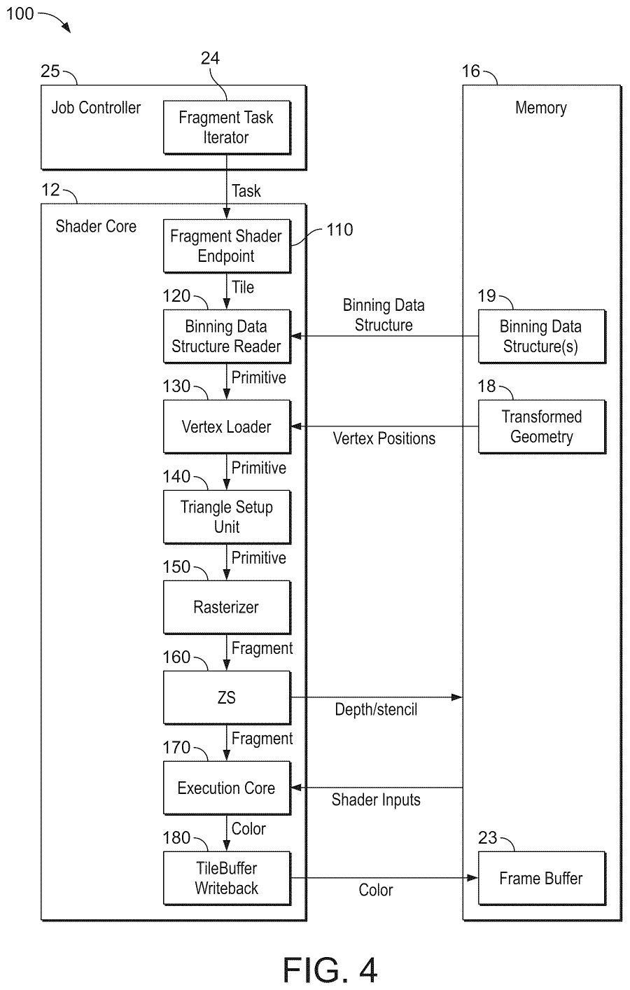

When a rendering processor 12, 13 is allocated a region to be processed for a render output (by being issued a corresponding rendering task), the rendering processor processes that region by executing a graphics processing pipeline for the tile(s) or parts thereof that the region corresponds to. This operation of a rendering processor is described in more detail below with reference to FIG. 4.

FIG. 4 shows the job controller 25 and the stages of the graphics processing pipeline that are carried out by a rendering processor 12. The stages carried out by the rendering processor 12 are executed after the tiling unit 21 of the graphics processor 3 has prepared the required binning data structure(s) 19.

Once the tiling unit 21 has completed the preparation of the binning data structure(s) 19, then a tile of the render output can be rendered with reference to its associated binning data structure(s).

To do this, respective tiles are processed by the graphics processing pipeline stages shown in FIG. 4. A respective tile may be processed as an individual (whole) tile or as plural sub-tiles that are each processed by the graphics processing pipeline stages separately and then combined.

The region allocator (or “fragment task iterator”) 24 allocates regions to the rendering processor 12 for processing by the graphics processing pipeline 100.

The region allocator 24 may thus schedule the rendering processors 12, 13 to generate a render output, which may, e.g. be a frame to display, by the tiles being processed by the graphics processing pipeline stages of the rendering processors 12, 13.

When the rendering processor 12 is allocated a region to be processed, a fragment shader endpoint 110 of the rendering processor 12 identifies one or more tiles that the region corresponds to (e.g. at least partially intersects or is covered by).

For a given tile that all or part of is to be processed, a binning data structure reader ('polygon reader') 120 identifies a set of primitives to be processed for that tile based on the binning data structure(s) (e.g. based on the primitives that are listed in a primitive list for that tile), and the set of primitives for the tile is then issued into the graphics processing pipeline 100 for processing.

A vertex loader 130 then loads in the vertices for the primitives, which are then passed into a primitive set-up unit (or ‘triangle set-up unit’) 140 that operates, inter alia, to determine, from the vertices for the primitives, edge information representing the primitive edges.

When it is determined that only part of a tile (a sub-tile) is to be processed (as opposed to the whole tile), before the primitives are passed to the rasteriser 150, primitives that will not contribute to (e.g. do not fall within) the sub-tile in question are in an embodiment discarded (culled). Primitives that will not contribute to the sub-tile can thereby be prevented from being passed to the rasteriser for rasterisation.

The primitives to be rasterised are then passed to the rasteriser 150, which rasterises the primitives into respective sets of one or more sampling points and generates for the primitives individual graphics fragments having appropriate positions (representing appropriate sampling positions) for rendering the primitives.

The fragments generated by the rasteriser 150 are then sent onwards to the rest of the pipeline for processing.

For instance, in the present embodiment, the fragments generated by the rasteriser 150 are subject to (early) depth (Z)/stencil testing 160, to see if any fragments can be discarded (culled) at this stage. To do this, the Z/stencil testing stage 160 compares the depth values of (associated with) fragments issuing from the rasteriser 150 with the depth values of fragments that have already been rendered (these depth values are stored in a depth (Z) buffer that is part of the tile buffer 22) to determine whether the new fragments will be occluded by fragments that have already been rendered (or not). At the same time, an early stencil test is carried out.

Fragments that pass the fragment early Z and stencil test stage 160 may then be passed to a fragment shading stage, in the form of a shader (execution/processing) core 170, for rendering.

The fragment shading stage 170 performs the appropriate fragment processing operations on the fragments that pass the early Z and stencil tests, so as to process the fragments to generate the appropriate rendered data.

This fragment processing may include any suitable and desired fragment shading processes, such as executing fragment shader programs for the fragments, applying textures to the fragments, applying blending, applying effects such as fogging or other operations to the fragments, etc., to generate the appropriate rendered data.

In the present embodiment, the fragment shading stage is in the form of a shader pipeline (a programmable fragment shader), and thus is implemented by an appropriate shader (processing/execution) core 170.

Thus, in the present embodiment, the fragment shading stage (execution core) 170 includes a programmable execution unit (engine) operable to execute fragment shader programs for respective execution threads (where each thread corresponds to one work item, e.g. an individual fragment, for the output being generated) to perform the required fragment shading operations to thereby generate rendered data. The execution unit can operate in any suitable and desired manner in this regard and comprise any suitable and desired processing circuits, etc..

Once the fragment shading is complete, the output rendered (shaded) fragment data is written to the tile buffer 22 from where it can be written out 180 to, for example, the frame buffer 23 (e.g. in the memory 16) for display. The depth value for an output fragment is also written appropriately to a Z-buffer within the tile buffer 22. (The tile buffer stores colour and depth buffers that store an appropriate colour, etc., or Z-value, respectively, for each sampling point that the buffers represent (in essence for each sampling point of a rendering tile that is being processed).) These buffers store an array of fragment data that represents part of the overall output (e.g. image to be displayed), with respective sets of sample values in the buffers corresponding to respective pixels of the overall output (e.g. each 2×2 set of sample values may correspond to an output pixel, where 4× multisampling is being used).

When a region allocated to the rendering processor 12 corresponds to all or part of more than one tile, the next tile for the region is then identified by the fragment shader endpoint 110 and is processed in the manner described above, and so on, until the processing of the region allocated to the rendering processor has been completed.

Once sufficient tiles have been processed to generate the entire render output (e.g. frame (image) to be displayed), the process can then be repeated for the next render output (e.g. frame) and so on.

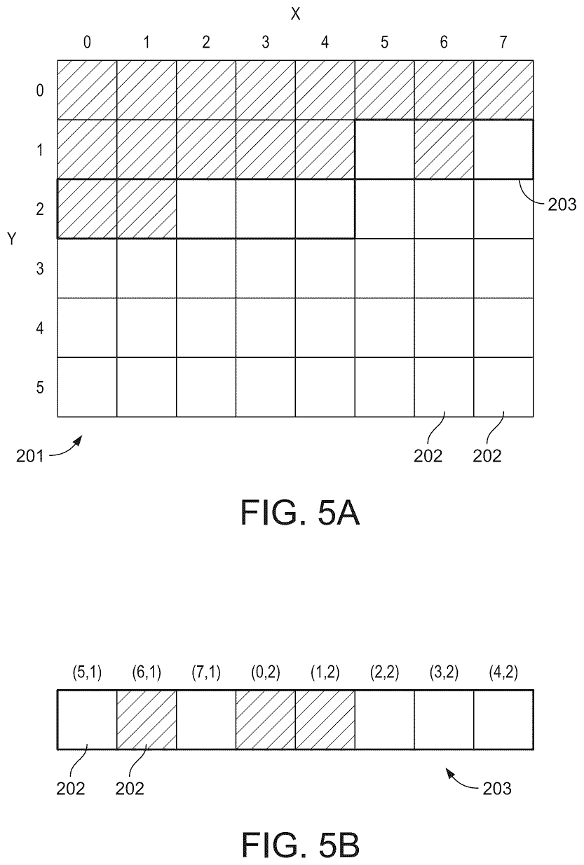

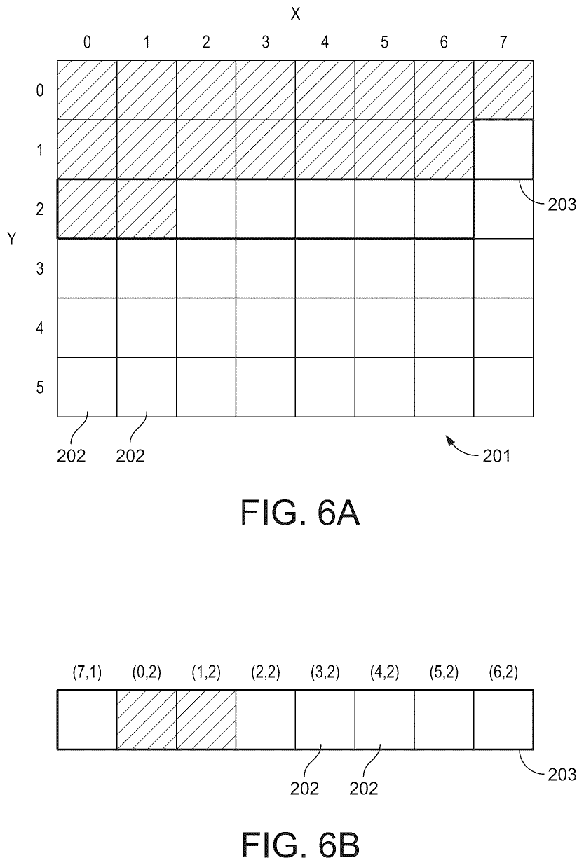

The use of a varying sub-set of regions during the allocation of regions of a render output in accordance with an embodiment of the technology described herein will now be described with reference to FIGS. 5A, 5B, 6A and 6B.

FIG. 5A shows a render output 201 divided into a plurality of regions 202 for allocation to the rendering processors 12, 13. The render output 201 is divided into 8×8 regions 202, with each region having a location in the render output 201 defined by co-ordinates (X, Y) where each of X and Y take values from 0 to 7. FIG. 5A shows the render output 201 part-way through the allocation of the regions 202, where shaded regions are regions that have been allocated for processing and unshaded regions are regions that are still to be allocated for processing. Regions (0,0) to (7,0) and (0,1) to (4,1) have all been allocated. Regions (5,1) to (7,1) and (0,2) to (4,2) are presently in a sub-set 203 of regions defined, in the present embodiment, by 8 consecutive regions in a raster order for the render output 201 with X as the inner dimension and Y as the outer dimension, where the sub-set 203 starts with, and includes, the first region in the raster order for the render output yet to be allocated.

FIG. 5B shows the sub-set 203 of regions at the same point in the allocation process shown in FIG. 5A. At this point, some regions 202 in the sub-set 203 have previously been allocated (regions (6,1), (0,2) and (1,2)) and others have not. Any of the regions 202 in the sub-set 203 yet to be allocated can be selected to be allocated next, and which region is selected is based on the tracking of the processing of one or more render outputs.

FIG. 6A shows the render output 201 after the next region has been allocated, and FIG. 6B shows the sub-set 203 at the same point in the allocation as FIG. 6A. In this case, region (5,1) was selected as the next region to be allocated for processing (compared to FIGS. 5A and 5B), and consequently the regions 202 within the sub-set 203 have changed based on region (7,1) now being the first region in the raster order yet to be allocated.

Another region 202 can then be selected to be allocated from the regions that are currently present within the sub-set, and so on, until all of the required regions 202 for the render output 201 have been allocated.

In other embodiments, the render output 202 could be divided into any other suitable number and configuration of regions 202, and the sub-set could contain (at a given time) any other suitable number of regions 202. It is not essential that which regions 202 are within the sub-set 203 is defined in the manner described for FIGS. 5A, 5B, 6A and 6B, and alternative suitable definitions could be used, such as a region being removed from the sub-set 203 when allocated, and replaced with a new region 202.

Controlling the allocation by selecting a next region to be allocated from the sub-set 203 of regions, rather than based on a fixed allocation order, the allocation order can be dynamically adjusted based on the tracking of one or more render outputs, and in embodiments at least this can provide a more efficient allocation order in terms of, for example, lower latencies, greater spatial coherency, less data bandwidth requirement, etc..

It can be seen from the above that the technology described herein, in its embodiments at least, can provide more efficient processing of a render output (e.g. in terms of lower latencies, greater spatial coherency, less data bandwidth requirement, higher throughput, lower energy consumption) by rendering processors when performing graphics processing. This is achieved in the embodiments of the technology described herein at least, by controlling the allocation of different regions of a render output to different ones of the rendering processor for processing based on the tracking of the processing of one or more render outputs by the rendering processors.

Although embodiments of the technology described herein have been described relating to performing graphics processing to render a render output, the technology described herein is also applicable more generally to processing a data array that is divided into a plurality of regions for allocation to processing circuits for processing, where the allocation of the regions to the processing circuits is controlled based on the tracking of the processing of one or more data arrays by the processing circuits.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processor that comprises plural rendering processors each operable to render regions that a render output is divided into for allocation to the rendering processors, the method comprising:
when rendering a render output:
allocating different regions of the render output to different ones of the rendering processors for processing; and
each rendering processor processing the region or regions allocated to it;
the method further comprising:
tracking the processing of one or more render outputs by the rendering processors; and
controlling the allocation of different regions of a render output to different ones of the rendering processor for processing based on the tracking of the processing of one or more render outputs by the rendering processors.

2. The method of claim 1, wherein the order in which regions of the render output are allocated to the rendering processors for processing is controlled based on the tracking of the processing of one or more render outputs by the rendering processors.

3. The method of claim 2, wherein the order in which regions of the render output are allocated to the rendering processors for processing is controlled by determining the order in which some of the regions of the render output are allocated to the rendering processors for processing after other regions of the render output have been allocated to the rendering processors.

4. The method of claim 1, comprising determining a provisional allocation order for regions of the render output, and wherein:
when a rendering processor is available for processing a region of the render output, which region of the render output the rendering processor is next allocated to process is based on the provisional allocation order and the tracking of the processing of one or more render outputs by the rendering processors.

5. The method of claim 4, comprising selecting which region of a render output a rendering processor is next allocated to process from a sub-set of regions of the render output, wherein which regions are present within the sub-set is based on the provisional allocation order, and which region is selected from the sub-set to be next allocated to the rendering processor is based on the tracking of the processing of one or more render outputs by the rendering processors.

6. The method of claim 4, comprising:
generating rendering tasks for processing the render output, wherein different ones of the rendering tasks correspond to different ones of the regions of the render output, and wherein a region of the render output is allocated to a rendering processor for processing by issuing a rendering task corresponding to the region to the rendering processor for processing;
wherein the rendering tasks for the render output are generated in an order according to the provisional allocation order.

7. The method of claim 1, wherein tracking the processing of one or more render outputs by the rendering processors comprises tracking which region or regions of a render output are currently being processed by the rendering processors.

8. The method of claim 1, wherein tracking the processing of one or more render outputs by the rendering processors comprises tracking which region or regions of a render output are processed by which of the rendering processors.

9. The method of claim 1, wherein tracking the processing of one or more render outputs by the rendering processors comprises tracking a rate at which different ones of the rendering processors process regions of a render output.

10. The method of claim 2, comprising controlling the order in which some of the regions of the render output are allocated to the rendering processors for processing based on the tracking of the processing of other regions of the render output.

11. The method of claim 2, wherein the allocation of regions of a render output to the rendering processors for processing is controlled based on the tracking of the processing of another render output.

12. A graphics processor, comprising:
a plurality of rendering processors, each operable to render regions that a render output is divided into for allocation to the rendering processors;
a region allocation circuit configured to allocate regions of a render output to be processed to rendering processors for processing; and
an allocation controlling circuit configured to:
track the processing of one or more render outputs by the rendering processors; and
control the allocation of regions of a render output to the rendering processors for processing based on the tracking of the processing of one or more render outputs by the rendering processors.

13. The graphics processor of claim 12, wherein the allocation controlling circuit is configured to control the order in which regions of the render output are allocated to the rendering processors for processing based on the tracking of the processing of one or more render outputs by the rendering processors.

14. The graphics processor of claim 12, wherein the allocation controlling circuit is configured to:
control which regions are present within a sub-set of regions of a render output, wherein the sub-set comprises regions that can be next allocated to a rendering processor for processing; and
select which region from the sub-set is next allocated to a rendering processor for processing based on the tracking of the processing of one or more render outputs by the rendering processors.

15. The graphics processor of claim 14, comprising a rendering task generating circuit configured to generate rendering tasks for processing a render output, wherein different ones of the rendering tasks correspond to different ones of the regions of a render output, and wherein the rendering processors are operable to process regions of a render output by processing the respective rendering tasks corresponding to the respective regions;
wherein the region allocation circuit is configured to allocate a region of a render output to a rendering processor for processing by issuing a rendering task corresponding to the region to the rendering processor for processing; and
wherein the allocation controlling circuit is configured to control which regions are present within the sub-set based on an order in which the rendering tasks are generated.

16. The graphics processor of claim 12, wherein the allocation controlling circuit is configured to track the processing of one or more render outputs by the rendering processors by tracking one or more of:
which region or regions of a render output are currently being processed by the rendering processors; and
which region or regions of a render output are processed by which of the rendering processors.

17. The graphics processor of claim 12, wherein the allocation controlling circuit is configured to track the processing of one or more render outputs by the rendering processors by tracking a rate at which different ones of the rendering processors process regions of a render output.

18. The graphics processor of claim 12, wherein the allocation controlling circuit is configured to control the order in which some of the regions of a render output are allocated to the rendering processors for processing based on the tracking of the processing of other regions of the render output.

19. The graphics processor of claim 12, wherein the allocation controlling circuit is configured to control the allocation of regions of a render output to the rendering processors for processing based on the tracking of the processing of another render output by:
tracking which region or regions of a first render output are allocated to which of the rendering processors for processing; and
selecting a region of a second render output to allocate to a rendering processor for processing based on which region or regions of the first render output the rendering processor was allocated to process.

20. A non-transitory computer-readable storage medium storing computer software code that when executing on one or more processors performs a method of operating a graphics processor that comprises plural rendering processors each operable to render regions that a render output is divided into for allocation to the rendering processors, the method comprising:
when rendering a render output:
allocating different regions of the render output to different ones of the rendering processors for processing; and
each rendering processor processing the region or regions allocated to it;
the method further comprising:
tracking the processing of one or more render outputs by the rendering processors; and
controlling the allocation of different regions of a render output to different ones of the rendering processor for processing based on the tracking of the processing of one or more render outputs by the rendering processors.
